(19) United States
(12) Patent Application Publication
(10) Pub. No.: US 2025/0313908 A1
(43) Pub. Date: Oct. 9, 2025

(54) Method for the Surface Treatment of Flexible Covers for Use in the Automotive and Aeronautical Industry

(71) Applicant: GRUPPO MASTROTTO SPA, Arzignano (IT)

(72) Inventors: Raymond Ruckenstuhl, Arzignano (IT); Massimo Pajusco, Montebello Vicentino (IT)

(21) Appl. No.: 18/866,920

(22) PCT Filed: May 18, 2023
(86) PCT No.: PCT/IB2023/055124

§ 371 Date: Nov. 18, 2024

(30) Foreign Application Priority Data
May 23, 2022 (IT) 102022000010658

(51) Int. Cl. C14C 11/00; C09D 169/00; C09D 175/04

(52) U.S. Cl. CPC C14C 11/006; C09D 169/00; C09D 175/04

(57) ABSTRACT

A method for the treatment of flexible laminar covers is described. One aspect includes selecting a low-quality material with a visible surface. A first layer of a first resin in a liquid state with a weight of a first predetermined value is deposited on the first surface. The resin is dried by applying a heat source to obtain an intermediate laminar semi-finished product, A second layer of a second resin in a liquid state with a weight of a second predetermined value is deposited on an active surface of a laminar support. The resin is dried by applying a heat source. The laminar support is coupled with the laminar semi-finished product so as to face the active surface to obtain a coupled sandwich. The sandwich is calendered by applying predetermined pressure and temperature. The sandwich is heated to a predetermined temperature so as to obtain a laminar finished product.

### FIELD OF THE INVENTION

The present invention generally relates to the field of flexible laminar cover materials and it particularly relates to a method for the surface treatment of such cover materials, such as hides and skins, intended for use in the automotive and aeronautical industry.

### BACKGROUND ART

The use of hides, natural or synthetic leather and other flexible laminar materials in various fields, such as for example the footwear, furnishing, clothing, and automotive industries as well as transportation vehicles in general has long been known.

Although all these industries have in common the use of flexible laminar base materials as protection or cover, they have very different requirements depending on the use of the end product.

For example, a leather sofa is subject to continuous friction by end-users and therefore the leather must have good abrasion and wear resistance over a long period of time.

Furthermore, it is desirable that the leather covering the sofa can be easily cleaned and that it is not subject to more or less permanent stains and other unpleasant marks visible on the outer surface of the sofa.

Another example of finished products is leather goods accessories, such as leather bags and wallets, which in use are continuously opened and closed, in such a way that the leather or fabrics that they are made of have good flexibility and show no signs of wear such as creases, wrinkles and deterioration of possible surface patterns.

Hence, the flexible laminar covers used in these technical fields must necessarily have inherent properties that differ according to the field of application.

Some of the properties of leather derive from the type of processing carried out during tanning. However, most of the properties are generally inherent to the raw material.

Therefore, depending on its quality, a leather will be more appropriate for certain fields of application than for others. In particular, fields of application that require an end product with high performance for a long period of time will necessarily require a high-quality leather.

However, high-quality leather is hard to find, in high demand and very costly.

It is known in the industry that the expression “high/good quality leather” is used to indicate leather with a small number of defects per unit of measured surface.

It is also known that typical leather defects comprise scratches, scars, holes, cuts, pest damage and stains, mostly due to diseases of the animal or to the storage of the skin under inappropriate conditions.

Among the various fields using leather, it is known that the automotive and aeronautical fields require the use of high-quality leather.

Typically, besides being aesthetically pleasant, the leather of a steering wheel must withstand high temperature variations, exposure to sunlight and traction exerted by the driver while driving, for many years.

In the aeronautical industry, besides the requirements described above, the seats and interiors must also comply with strict safety requirements, in particular to make the accessories flame-retardant and self-extinguishing.

Techniques and methods are known which are adapted to eliminate and/or mitigate the defects present on the leather so as to improve the quality of the leather so that it can be used in the automotive and aeronautical industries.

One of the most known techniques is grinding, which is usually carried out using a machine provided with abrasive rollers or strips, or by using hand-rubbed ground powder on the surface of the leather.

During such processing, the leather is firstly grouted on the grain side and then ground so as to even the excess material with respect to the grain surface of the leather reducing the defects thereof.

However, grinding is not sufficient to also eliminate the deepest defects and it cannot be pushed beyond given limits otherwise most of the surface material will be removed.

Furthermore, an intense grinding would damage the surface pattern of a leather, which would require a subsequent printing step to confer a desired aesthetic effect to the leather again.

WO2013/032107 discloses a method of producing synthetic leather suitable for use in the automotive, footwear, furnishing and clothing industries.

This known method provides for the deposition of a polyurethane resin dispersed in water on the surface of a “release” paper with a concave-convex pattern. The release paper then passes through a first furnace and it is then sprayed with a urethane-based adhesive.

After drying the adhesive layer through a second furnace, the release paper is coupled with the synthetic leather by calendering to form a sandwich.

The release paper-synthetic leather sandwich is then heat-treated at 90-110° C. for 12-24 hours and the synthetic leather is then detached from the release paper to be used.

A first drawback of this technique lies in the fact that the method is only suitable for synthetic leather, which could potentially lead to loss of interest in using an unnatural product by manufacturers operating in the automotive or aeronautical industry.

Furthermore, this known method requires high production times, especially in the final step where the release paper-synthetic leather sandwich has to stay for several hours in a treatment chamber.

In order to at least partially overcome these drawbacks, there have been developed methods for the production of natural leather to make it suitable for use in the automotive industry as upholstery lining, for example as described in CN105040461.

This method provides for a first step of applying a polyurethane aqueous dispersion to the release paper surface and drying at 110-120° C. In the subsequent step, polyurethane and a swelling agent are applied to the dry surface through mechanical expansion. The entirety is heat treated at 110-120° C. for 20-40 minutes.

The last step provides for laminating the release paper with a leather and drying at 100-120° C. for 10-15 hours. At the end of the treatment, the release paper is detached obtaining the leather processed and suitable for the automotive industry.

A first drawback of such known method is the high energy consumption required to process a single leather. As a matter of fact, all drying processes are carried out at temperatures above 100° C. and for a very long time.

Furthermore, such method is not suitable for continuous leather production, since in the last step the semifinished release paper-leather has to stay for several hours in a furnace in order to transfer the polyurethane layers to the surface of the leather.

EP3097230 discloses a method for enhancing hide by using a polyurethane resin spread on the hide and on release paper using relatively high drying temperatures.

The leather and release paper are then coupled and calendered so as to obtain a final laminar product.

Nevertheless, these known methods are financially demanding and they do not allow the continuous production of leather with relatively low or medium initial quality that can meet the requirements of the automotive and aeronautical industry.

### TECHNICAL PROBLEM

In the light of the prior art, the technical problem addressed by the present invention is how to obtain cover products with high-end quality requirements typical of the automotive and aeronautical industries starting from flexible laminar products of relatively low-quality reducing energy consumption.

### SUMMARY OF THE INVENTION

The object of the present invention is to solve the aforementioned problem by providing a method for the surface treatment of flexible cover materials intended for use in the automotive and aeronautical field which is highly efficient and cost-effective.

Another object of the present invention is to provide a method for the surface treatment of cover materials of the type indicated above which allows to obtain products that can meet the requirements of the automotive and aeronautical industry.

A particular object of the present invention is to provide a method for the surface treatment of cover materials of the type indicated above which allows the use of low-quality leather as starting material.

Another object of the present invention is to provide a method for the surface treatment of cover materials of the type indicated above which allows to also eliminate significant defects from the starting base material.

A further object of the present invention is to provide a method for the surface treatment of cover materials of the type indicated above, that is easy to implement.

Another object of the present invention is to provide a method for the surface treatment of cover materials of the type indicated above which allows to manufacture the end products continuously and in a short time.

A further object of the present invention is to provide a method for the surface treatment of cover materials of the type indicated above which limits waste of consumption materials.

The objects mentioned above and others which will be more apparent hereinafter, are achieved by a method for the surface treatment of flexible laminar cover materials, such as hides and skins, intended for use in the automotive and aeronautical industry, according to claim 1.

More detailed method characteristics are indicated in dependent claims.

### BRIEF DESCRIPTION OF THE DRAWINGS

Further features and advantages of the invention will be more apparent in the light of the detailed description of a preferred but not exclusive embodiment of a method for the surface treatment of flexible laminar cover materials like the one mentioned above, shown by way of non-limiting example with reference to the drawings below, wherein:

FIG. 1 is a block diagram of the steps of the method according to the invention;

FIG. 2 is a representation of a low-quality laminar material with surface defects before it is treated according to the method of the invention;

FIG. 3 is a top perspective view of a laminar material;

FIG. 4 is a lateral view of a laminar material provided with a first resin deposited on the surface thereof;

FIG. 5 is a lateral view of a laminar support provided with a second resin deposited on the surface thereof;

FIG. 6 is a lateral view of a sandwich consisting of the laminar material and the laminar support provided with the respective resins;

FIG. 7 is a lateral view of a finished product obtained using the method according to the invention;

FIG. 8 is a representation of the finished product of FIG. 7;

FIG. 9 is a comparison of a laminar material before and after the treatment according to the method of the invention;

FIG. 10 is a lateral view of a plant suitable for the surface treatment of laminar materials according to the method of the invention.

### DETAILED DESCRIPTION OF A PREFERRED EMBODIMENT

With particular reference to the figures, there is shown a method for the surface treatment of flexible laminar cover materials M, in particular hides and skins, intended for use in the automotive and aeronautical industry.

Obviously, the end products obtained using the present method may also be used in industries other than automotive or aeronautical, such as for example furnishing, footwear and leather goods, without departing from the scope of the protection of the invention.

As a matter of fact, a particular object of the present method is to provide an end product that can meet the high application standards required by certain particular industries.

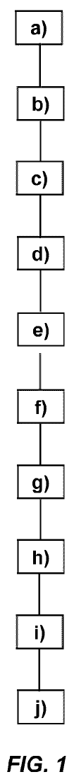

As shown in FIG. 1, the method initially provides for a step a) of selecting a relatively low-quality laminar material M, with a visible surface V having significant surface defects.

Hereinafter, the expression “low quality” or “relatively low quality” is used to indicate a hide or leather with a number of defects such to be generally considered inappropriate for manufacturing products for the automotive and aeronautical industries through known state-of-the-art techniques.

Typical surface defects of leather are scratches, scars, holes, cuts, pest damage and stains due to diseases of the animal or to the storage of the leather under inappropriate conditions.

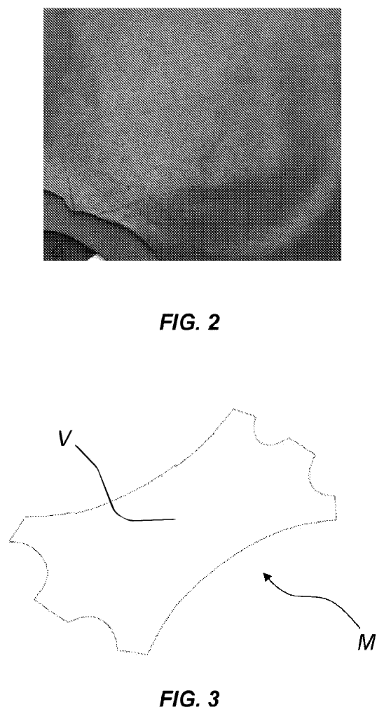

An example of laminar material M provided with surface defects used in the present method is shown in FIG. 2.

Advantageously, besides natural and synthetic hides and skins, the method of the present invention may also be applied to alternative laminar materials M selected from microfibres, impregnated fabrics, resin-coated fabrics, non-woven fabrics, knitted fabrics, finished fabrics and the like.

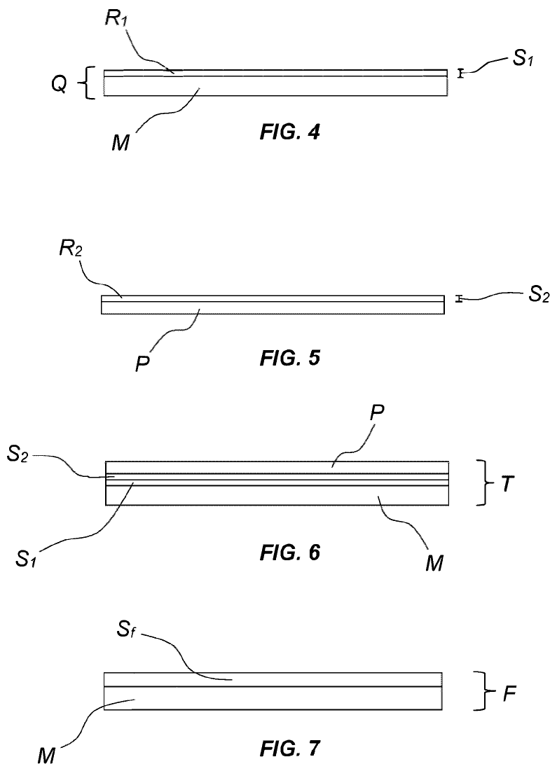

Subsequently, there is provided a step b) of depositing on the visible surface V of the laminar material M a first layer S₁ of a first resin R₁ in the liquid state with a weight of a first predetermined value, as shown in FIGS. 3 and 4.

Advantageously, the first resin R₁ is a mixture of individual components selected from the group comprising polyurethanes, acrylics, and polycarbonates with a relatively high degree of stickiness.

The main purpose of such first resin R₁ is to fill the defects present and to confer a sticky and resistant effect such as abrasion and wear to the physical agents.

The special composition of the first resin R₁ allows its deposition on the visible surface V of the laminar material M by means of techniques selected from the group comprising spray deposition, roller deposition and doctor blade deposition.

In the case of spray deposition, this is carried out by means of a plurality of nozzles or guns arranged above the laminar material M in order to dispense the first resin R₁ on the visible surface V.

In the case of roller deposition, the first resin R₁ is loaded into a metering device, for example of the hopper type, and then deposited evenly on the visible surface V of the laminar material M by means of a roller.

Similarly, the first resin R₁ is deposited by a metering device and then evened using a blade.

However, it cannot be ruled out that other known systems can be used for the even distribution of the first resin R₁ in the liquid state.

Irrespective of the deposition technique used, what matters for the purposes of the invention is that the first predetermined weight value of the first layer S₁ of the first resin R₁ is comprised between 21.5 g/m² and 269 g/m² on wet basis.

Suitably, the resin R₁ is deposited on a pre-treated laminar material M.

As a matter of fact, before the deposition step b), the laminar material M may be subjected to one or more optional preliminary treatment steps selected from the group comprising drying, brushing, splitting, fulling, staking and the resin-coating of the flesh side.

If the laminar material M has a large number of defects, the laminar material M may optionally be subjected to grouting and grinding before the deposition step b).

However, should a grinding step be necessary, it will not be carried out intensively so as to avoid a further printing step on the laminar material M. Therefore, the method described so far allows to reduce processing times, as well as a significant saving.

After the deposition step b), there is provided a step c) of drying the first resin R₁ by applying a heat source so as to obtain a partially dried intermediate laminar semi-finished product Q.

By way of example, suitable heat sources for the implementation of drying step c) are selected from the group comprising infrared lamps, air convection ovens, steam ovens, diathermic oil ovens and similar microwave and radio frequency applicators or—alternatively—room temperature drying.

The method further provides for a step d) of providing a laminar support P having an active surface with a pattern to be transferred on the visible surface V of the laminar material M;

Advantageously, the laminar support P is selected from a release paper, a nylon laminate, a mylar or polyester sheet, a silicone mat or made of other extruded laminar materials.

Depending on the type of end product to be obtained, there is selected a laminar support P with a certain concave and/or convex surface pattern which is intended to be transferred to the visible surface V.

In a preferred embodiment, the laminar support P is provided as rolls, which are unrolled and supplied continuously with the active surface facing upwards during the implementation of the method.

Therefore, there is provided a step e) of depositing on the active surface of the laminar support P a second layer S₂ of a second resin R₂ in the liquid state with a weight of a second predetermined value, as shown in FIG. 5.

Preferably, the second resin R₂ is selected from the group comprising polyurethanes, polycarbonates or acrylics with addition of crosslinking agents of the isocyanate, polyurea, carbodiimide, aziridine and epoxy type and the like.

The main purpose of the second resin R₂ is to cover the laminar support P, to confer a relief with a predetermined shape and to extend the average service life of the laminar support P.

Furthermore, appropriate pigments, dyes and anilines can be added to the second resin R₂ in order to reproduce a coloured pattern on the visible surface V of the laminar material M.

The deposition of the second resin R₂ is carried out using techniques selected from the group comprising spray deposition, roller deposition and doctor blade deposition, as indicated for the deposition of the first resin.

Suitably, the second predetermined weight value of the second layer S₂ of said second resin R₂ is comprised between 0.2 g/m² and 50 g/m² on dry basis.

The laminar support P then proceeds towards a drying station, where a step f) of drying the second resin R₂ by applying a heat source is carried out.

Preferably, the drying step f) of the second layer S₂ is carried out at a relatively low temperature comprised between 25° C. and 140° C.

Optionally, steps e) and f) may be repeated before proceeding further with the method of the present invention.

Indeed, depending on the shape of the surface pattern on the laminar support P and on the type of covers intended to be imparted in the final product, there will be provided for a predetermined number of deposition e) and drying f) cycles to be performed.

Just like in the case of step c) of drying the first resin R₁, also in step f) there may be used systems provided with infrared lamps or air convection ovens, steam ovens, gas ovens, radio frequency and microwave ovens and the like, or at room temperature.

After the drying step f), the laminar support P may be further processed by means of a heated cylinder or press in order to further increase the degree of stickiness with the aim of improving the adhesion of what will be the surface layer of the end product.

Advantageously, steps a)-c) and steps d)-f) of the method according to the invention are carried out simultaneously, in order to obtain an intermediate laminar semi-finished product Q provided with a partially dry first layer S₁ and at the same time a laminar support P with a dry second layer S₂.

Subsequently, there is carried out a step g) of coupling the laminar support P with the intermediate laminar semi-finished product Q so as to face the visible surface V to the active surface and obtain a coupled sandwich T, as shown in FIG. 6.

It should be observed that before carrying out the coupling step g), the second resin R₂ is dried substantially completely, while the first resin R₁ should not be dried completely as it must maintain a certain stickiness.

Then, there is provided a step h) of calendering the coupled sandwich T by applying predetermined pressure and temperature. In one aspect, this predetermined pressure and temperature are a first predetermined pressure and temperature.

In particular, the calender has a heated steel upper cylinder and a lower cylinder, optionally wrapped by sponges or felt, opposite to the upper cylinder. Through these cylinders there passes the coupled sandwich T in order to facilitate the adhesion of the first layer S₁ of the laminar material M with the second layer S₂ of the laminar support P.

Suitably, this step h) of calendering the coupled sandwich T is carried out at a first pressure comprised between 1 MPa e 8 MPa, preferably proximal to 3 MPa, and at a first temperature comprised between 50° C. and 150° C.

Once through with the calendering step, the sandwich T continues in an oven where drying is completed.

Therefore, there is provided a step i) of heating the calendered sandwich T at a predetermined temperature so to complete the drying and crosslinking of the resins R₁, R₂ and obtain a laminar finished product F. In one aspect, this predetermined temperature is a second predetermined temperature.

In particular, in this step i) there is carried out the crosslinking of the resins R₁, R₂ which take the shape of the pattern present on the active surface of the laminar support P, which will therefore be reproduced on the visible surface V of the laminar material M.

Suitably, the step i) of heating the calendered sandwich T is carried out at a second temperature comprised between 40° C. and 100° C. for a period of time comprised between a few seconds and a few minutes, with an advancement speed of the hide preferably comprised between 4 and 7 m/min.

At the end of processing, after the heating step i), there is provided a step j) of detaching the laminar finished product F from the laminar support P.

The laminar finished product F will optionally be finished, for example by removing any excess resins, and then stored to be sent to the end users or to the department designated for the production of articles for the automotive or aeronautical industries.

Therefore, the laminar finished product F has, on the surface thereof, a pattern transferred from the selected laminar support P, the pattern being monochromatic or variously coloured or transparent depending on the pigments added to the second resin R₂ as mentioned above.

As better shown in FIG. 7, the deposition of the first R₁ and of the second R₂ resin is carried out by providing a layer with substantially constant final thickness S_{f} on the laminar finished product F which—after complete crosslinking—is comprised between 10 μm and 200 μm.

In particular, the final layer S_{f}, formed by the crosslinking of the first R₁ and the second R₂ resin, represents the pattern adhered to the visible surface V of the laminar material M.

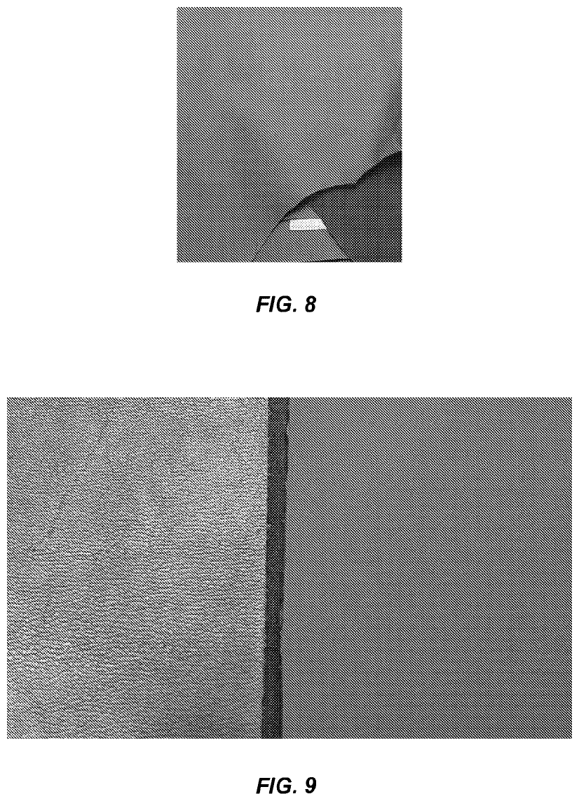

Experimentally, it has been shown that the final thickness S_{f} formed by the combination of the first R₁ and the second R₂ resin is suitable to obtain a laminar finished product F, shown in FIG. 8, which completely conceals the initial surface defects, while exhibiting structural and aesthetic qualities that meet the requirements of the automotive and aeronautical industries.

Advantageously, the laminar support P used for the production of the laminar finished product F will not be discarded, but can be reused.

As a matter of fact, after the step j) of detaching the laminar finished product F, the laminar support P is cleaned of any residual resins using an adhesive tape and rewound so as to be reused.

In a per se known manner, even other systems for cleaning the laminar support P, such as compressed air or suctioning of the residues, may be used in a per se known manner.

The rewound laminar support P may be reused continuously in a new cycle of the present method, or the roll—after initial use—may be removed from the system and replaced with a new one with a different pattern, so as to provide a new, different finished product.

By cleaning the laminar support P using an adhesive tape, a determined roll may be used for a total number of cycles comprised between 1 and 100, therefore leading to significant economic and ecological benefits.

When the deterioration is such that the surface pattern is no longer clear enough, the roll is sent to waste for recycling.

It is clear that the method described above does not necessarily require steps for applying filler and pre-primer to the initial flexible laminar material M as is generally carried out in the techniques known in the industry for the production of products suitable for automotive and aeronautical industries.

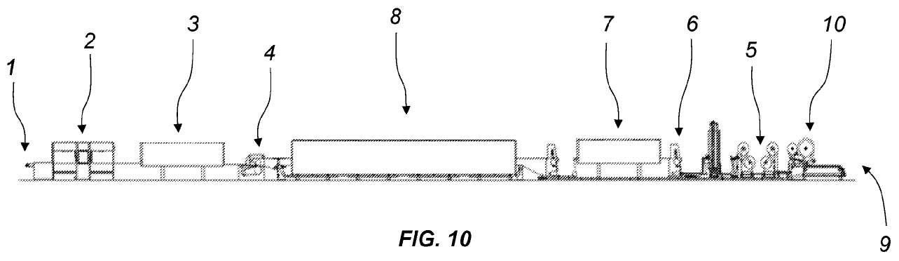

FIG. 9 shows a comparison between a laminar material M with surface defects before being subjected to the present method and a laminar finished product F obtained.

Furthermore, besides avoiding further costs due to grouting and base primer, the method of the present invention requires reduced time to produce end product suitable for the automotive and aeronautical industries, with relative economic benefits.

An additional advantage of the present method lies in the fact that it can be implemented by a plant of the known type like the one schematically shown in FIG. 10 by way of example.

In detail, at an end of the plant there is provided for an inlet area 1 for the laminar material M appropriately pre-treated as described above, followed by a first station 2 provided with means appropriate for depositing the first resin R₁ resin on the surface of the laminar material M.

Subsequently, moved by rollers, the laminar material M passes through a first drying area 3 where the intermediate laminar semi-finished product Q is provided.

The dried intermediate laminar semi-finished product Q is then coupled to the laminar support P provided with the second resin R₂ by means of the pair of rollers present in the coupling area 4.

The laminar support P was previously prepared by mounting the roll, selected depending on the pattern to be replicated, in the unrolling area 5. The unrolled laminar support P is passed through a second station 6 provided with means for the deposition of the second resin R₂ according to the present method.

Therefore, the laminar support P provided with the second resin R₂ was passed through a second drying area 7 before reaching the coupling area 4.

Possibly, as described above, the deposition and drying of the second resin R₂ may be repeated before the coupling with the intermediate laminar semi-finished product Q.

After the coupling, the formed calendered sandwich T is advanced through a third drying area 8 before reaching the final station 9 where the laminar finished product F provided with the surface pattern is detached from the laminar support P.

Lastly, the laminar support P passes through a cleaning area 10 before being rewound.

In a per se known manner, the cleaning area 10 may provide for automated mechanical cleaning means and/or staff designated to manually clean the laminar support P.

Given that the method is easy to implement, there can be used a plant similar to the one shown in FIG. 10 suitably modified according to the needs and availability of a user.

For example, instead of furnaces for drying the resins R₁ and R₂, lamps could be provided for in proximity to the belt which advance the laminar material M and the laminar support P.

Or, there could be used a laminar support P with a smooth active surface, that is without a surface pattern, replacing one of the cylinders in the coupling area 4 with a cylinder with the surface suitably engraved so as to impart a predetermined pattern on the surface of the sandwich T during step h), and therefore on the laminar product M.

Therefore, the method of the present invention has the additional advantage of being able to be implemented in existing installations without having to purchase new dedicated equipment.

### Tests for Automotive and Aeronautical Industry

Hereinafter are disclosed some examples of tests conducted on laminar finished products α and β obtained using the method described above.

In particular, a product suitable for use as a steering wheel cover, indicated in its entirety as product α, and a product suitable to be used as a seat cover, indicated in its entirety as product β, were tested.

Hereinafter, the products α and β are compared with the respective products for steering wheels and seats, respectively referred to as conventional product θ and conventional product Ω, obtained by spraying directly—on the leather—a common polyurethane resin and then drying in the oven.

Furthermore, for each type of test, the minimum values required by the automotive and aeronautical industries for the practical application of a leather product are reported.

### Adhesion Test of Finishes

The test is accomplished according to DIN EN ISO 11644 international standard.

Specifically, a sample with a width measuring 1 cm is glued to a fixed plate along the flesh side by means of a one-component cyanoacrylate adhesive with the finished surface facing upwards.

A dynamometer is coupled to the finishing of the sample, and an upward vertical pulling force is applied at a constant speed of 100 mm/min until the finishing is detached from the leather. The pulling is performed in some tests along the longitudinal direction of the sample, and in other tests in the transverse direction.

A diagram of the separation of the finishing on a distance of 30 mm is recorded.

This test is performed on dry or wet bases by wetting the sample with water or with an organic solvent.

The results of the adhesion tests of the finishes for steering wheels and seats are respectively reported in Table 1 and Table 2.

TABLE 1
Comparison of adhesion tests of finishes for steering wheels

| | Minimum | | Conventional |
|---|---|---|---|
| | required value | Product α | product θ |
| Test type | (N/cm) | (N/cm) | (N/cm) |
| On dry basis | ≥6 | Long: 31.41 | Long: 15.63 |
| | | Transv: 17.95 | Transv: 14.99 |
| Wet with water | ≥2.5 | Long: 13.55 | Long: 6.98 |
| | | Transv: 11.00 | Transv: 7.05 |
| Wet with | ≥4 | Long: 8.72 | Long: 6.03 |
| methyl acetate | | Transv: 10.51 | Transv: 5.43 |

As observable Table 1, the product a obtained through the method of the present invention fully meets—in all tests—the requirements required in the automotive industry for the construction of steering wheels.

Furthermore, the product α showed a higher adhesion value of the finishing with respect to the reference conventional product θ in all tests conducted.

TABLE 2
Comparison of adhesion tests of finishes for seats

| | Minimum | | Conventional |
|---|---|---|---|
| | required value | Product β | product Ω |
| Test type | (N/cm) | (N/cm) | (N/cm) |
| On dry basis | ≥4 | Long: 14.56 | Long: 8.21 |
| | | Transv: 15.50 | Transv: 8.09 |
| Wet with water | ≥1.2 | Long: 2.28 | Long: 1.30 |
| | | Transv: 2.73 | Transv: 1.27 |
| After 100,000 | ≥3.5 | Long: 10.18 | Long: 5.64 |
| flexions | | Transv: 11.02 | Transv: 5.18 |
| After exposure to | ≥3.5 | Long: 11.72 | Long: 7.05 |
| light | | Transv: 8.62 | Transv: 5.96 |

Table 2 clearly shows that the product β meets the requirements for manufacturing seats in all tests conducted.

In particular, the product β showed a higher finish adhesion with respect to the reference conventional product Ω in the tests with the sample wet with water.

### Rubbing Resistance Test

The test is conducted according to DIN EN ISO 11640 international standard.

Specifically, a leather sample is fixed between two clamps and stretched by 10% in a predetermined direction. A wool felt is subsequently applied to a plunger with a mass of 500 g which is positioned on the surface of the sample.

The plunger arranged in contact with the surface is moved along the predetermined stretching direction of sample for a pre-established number of cycles.

The felt pad is suitably soaked with specific chemical substances.

At the end of the test, each sample is evaluated with respect to a 1 to 5 quality grayscale of the test.

The results of the rubbing resistance test of the finishes for steering wheels and seats are respectively reported in Table 3 and Table 4.

TABLE 3
Comparison of rubbing resistance test for steering wheels

| | Minimum | | Conventional |
|---|---|---|---|
| | required value | Product α | product Ω |
| Test type | (1-5) | (1-5) | (1-5) |
| 100 cycles with | ≥4 | 5 | 4 |
| felt pad soaked | | | |
| with insecticide | | | |

TABLE 4
Comparison of rubbing resistance test for seats

| | Minimum | | Conventional |
|---|---|---|---|
| | required value | Product β | product Ω |
| Test type | (1-5) | (1-5) | (1-5) |
| 20 cycles with felt | ≥4 | 5 | 4 |
| pad soaked with | | | |
| gasoline | | | |

Tables 3 and 4 show that the products α and β of the present method not only show higher resistance values with respect to the conventional products θ and Ω, but also have a resistance clearly above the minimum value required for their practical use.

### Flexural Strength Test on Product β

The test is conducted according to DIN EN ISO 5402 international standard.

Specifically, the sample to be analysed consists of a leather strip which is folded on itself with the surface to be tested facing inwards. The lower end of the sample is locked using a fixed clamp of a flexometer, while the upper end is engaged by a movable clamp of the instrument, which—oscillating—it bends the leather strip.

The samples are stressed to bend after exposure to light for 10,000 cycles. A test set was conducted by bending the samples along their longitudinal direction, and a set by bending them along the transverse direction thereof.

At the end of the analysis, the condition of the surface of each individual sample was evaluated using an optical microscope so as to detect the presence of cracks and/or wrinkles.

The results obtained are reported below in Table 5.

TABLE 5
Comparison of bending resistance tests for seats

| Test type | Product β | Conventional product Ω |
|---|---|---|
| 10,000 cycles after | Long: intact | Long: intact |
| exposure to light | Transv: intact | Transv: intact |

As clearly shown in Table 5, it was found that the product β showed no obvious signs of degradation after 10,000 cycles.

### Abrasion Resistance Test on Product β According to the Martindale Method

The test is conducted according to the international standard DIN EN ISO 17076-2.

A sample of leather measuring 12 cm in diameter is fixed at the upper part of a metal plate which has some semi-spheres on the surface.

A plunger with a head provided with an abrasive fabric is brought into contact with the sample by applying a 12 kPa pressure. Subsequently, the plunger is moved so as to rub the head on the sample, along trajectories which simulate the Lissajous curve.

The visible defects present on the sample at the points of contact are counted at the end of the test.

Table 6 shows the results obtained in the test.

TABLE 6
Comparison of abrasion resistance tests for seats

| | Minimum | | Conventional |
|---|---|---|---|
| | required value | Product β | product Ω |
| Test type | (# defects) | (x) | (x) |
| 1,000 cycles | <4 | 0 | 3 |

Table 6 clearly shows that unlike the conventional product Ω, product β had no abrasion defects after a total of 1,000 cycles.

### MIE Test for Abrasion Resistance of Seams on Product β

The test is conducted according to Renault D47 553 B standard.

Two leather strips are sewn together so as to obtain a substantially rectangular sample. An end of the sample is fixed using a clamp, while the opposite end is attached to a 1 kg weight so as to keep the sample stretched.

Subsequently, a 5 kg mechanical arm weighing is operated with continuous movement along the seam for a predetermined number of cycles.

Every 100 cycles, the sample is recovered and the cracks/abrasions/tears present on the surface are counted. The results are shown in Table 7 reported below.

TABLE 7
Comparison of abrasion resistance tests for seat seams

| | Product β | Conventional product Ω |
|---|---|---|
| Test type | (# defects) | (# defects) |
| Every 100 cycles | 1 defect after 600 cycles | 4 defects after 200 cycles |

The product β did not show signs of abrasion until 600 cycles, unlike the conventional product Ω which already had a consistent number of defects that had ruined the surface thereof after 200 cycles.

### Stress Test on Adhesion of Finishes on Product β

The test is conducted according to ISO 105-B06 international standard.

The samples are placed in the chamber in which the internal temperature and humidity can be adjusted. Specifically, the samples inside the chamber are exposed to direct light at an initial temperature of 65° C. and 30% relative humidity.

Subsequently, cycles are set to predetermined temperature and humidity for a selected period of time.

After processing in the chamber, the samples are examined under microscope and adhesion of the finishes is also tested as described above according to the ISO 11644 standard.

The results obtained are reported in Table 8.

TABLE 8
Comparison of stress tests on the seat finishes

| | Minimum | | |
|---|---|---|---|
| | required | | Conventional |
| Test type | value | Product β | product Ω |
| ISO 11644 after | ≥4 N/cm | Long: 15.10 N/cm | Long: 9.08 N/cm |
| 168 hours at | | Transv: 13.38 | Transv: 9.81 |
| 70° C. and 75% | | N/cm | N/cm |
| humidity | | | |
| ISO 11644 after | ≥4 N/cm | 8.24 N/cm | 6.91 N/cm |
| 381 hours of | | | |
| exposure to light | | | |
| followed by 168 | | | |
| hours at 70° C. | | | |
| and 75% | | | |
| humidity | | | |
| Evaluation after | // | Size and | Narrow sample |
| 381 hours of | | appearance intact | measuring 3 mm |
| exposure to light | | | length-wise and |
| followed by 168 | | | 1 mm width-wise |
| hours at 70° C. | | | |
| and 75% | | | |
| humidity | | | |

As observable in Table 8, the product β after treatment in the chamber showed no change in size and it maintained its initial surface appearance, thus indicating a higher resistance to climatic agents with respect to the conventional product Ω.

Furthermore, the product β met the ISO requirements of all adhesion tests performed on the finishes, showing a higher resistance with respect to the conventional product Ω.

In the light of the above, it is clear that a laminar finished product subjected to surface treatment using the method of the present invention meets the requirements required by the automotive and aeronautical industries.

It should be observed that, surprisingly, the products of the method obtained starting from low-quality leather have better structural properties with respect to the corresponding products made from medium to high quality leather according to conventional techniques specific to the industry.

Furthermore, as described above, the method of the present invention requires a smaller number of processing steps with respect to such known techniques of the industry, and the finished products are produced continuously.

In the light of the above, it is therefore clear that the present method for the surface treatment of flexible laminar cover materials achieves the pre-established objects and, in particular, it allows the production of finished products suitable for the automotive and aeronautical industries in a relatively short manner and with less waste of energy and consumables.

Although the method been described with particular reference to the attached figures, the reference numerals used in the description and in the claims are meant for improving the intelligibility of the invention and do not limit the claimed scope of protection in any manner whatsoever.

Throughout the description, reference to “an embodiment” or “the embodiment” or “some embodiments” indicate that a particular characteristic, structure or element described is comprised in at least one embodiment of the object of the present invention.

### INDUSTRIAL APPLICABILITY

The present invention can be applied at industrial level as it can be manufactured on industrial scale by industries belonging to the leather tanning and finishing industry.

1. A method of surface treatment of flexible laminar cover materials, such as hides and skins, intended for use in the automotive and aeronautical industry, comprising at least the following steps:
a) selecting a laminar material of relatively low quality with a visible surface having relatively extensive surface defects;
b) depositing on the visible surface of the laminar material a first layer of a first resin in a liquid state with a weight of a first predetermined value;
c) drying the first resin by applying a heat source so as to obtain an intermediate laminar semi-finished product;
d) providing a laminar support having an active surface with a pattern to be transferred on the visible surface of the laminar material;
e) depositing on the active surface of the laminar support a second layer of a second resin in a liquid state with a weight of a second predetermined value;
f) drying the second resin by applying a heat source;
g) coupling said laminar support with said intermediate laminar semi-finished product so as to face said visible surface with said active surface to obtain a coupled sandwich;
h) calendering said coupled sandwich by applying a first predetermined pressure and temperature;
i) heating the calendered sandwich at a second predetermined temperature to complete associated drying and crosslinking of the first resin and the second resin to obtain a laminar finished product;
j) detaching the laminar finished product from the laminar support;
characterized in that the deposition of said first resin and second resin is carried out with a layer with approximately constant final thickness on said laminar finished product which, after complete crosslinking, is of thickness between 10 μm and 200 μm, wherein said step i) of heating the calendered sandwich is carried out at a temperature between 40° C. and 100° C. for a period of time between a few seconds and a few minutes, with an advancement speed of the sandwich preferably between 4 and 7 m/min.

2. The method as claimed in claim 1, wherein said laminar support is selected from a group including release paper, nylon laminates, mylar or polyester sheets, and silicone mat, or made of other extruded laminar materials.

3. The method as claimed in claim 1, wherein said first resin is a mixture of individual components selected from a group comprising polyurethanes, acrylics and polycarbonates.

4. The method as claimed in claim 1, wherein said second resin is selected from a group comprising polyurethanes, polycarbonates or acrylics with an addition of crosslinking agents of an isocyanate, a polyurea, a carbodiimide, an aziridine and an epoxy type.

5. The method as claimed in claim 1, wherein before said step b) of deposition the laminar material is subjected to one or more preliminary treatment steps selected from a group comprising drying, brushing, splitting, fulling, staking and resin-coating of the flesh side.

6. The method as claimed in claim 1, wherein before said step b) of deposition the laminar material is subjected to grouting and grinding steps.

7. The method as claimed in claim 1, wherein the first value of weight of the first layer of said first resin is between 21.5 g/m² and 269 g/m² on a wet basis.

8. The method as claimed in claim 1, wherein said first resin is deposited using techniques selected from a group comprising spray deposition, roller deposition, doctor blade deposition.

9. The method as claimed in claim 1, wherein the second value of weight of the second layer of said second resin is comprised between 0.2 g/m² and 50 g/m² on a dry basis.

10. The method as claimed in claim 1, wherein said second resin is deposited using techniques selected from a group comprising roller deposition, doctor blade deposition.

11. The method as claimed in claim 1, wherein said step f) of drying said second layer is carried out at a temperature between 25° C. and 140° C.

12. The method as claimed in claim 1, wherein said step h) of calendering the coupled sandwich is carried out at a pressure between 1 MPa and 10 MPa and at a temperature between 50° C. and 150° C.

13. The method as claimed in claim 1, wherein after said step j) of detachment of the laminar finished product, the laminar support is cleaned of any residual resins and rewound to be reused.
